(19) United States
(12) Patent Application Publication
(10) Pub. No.: US 2024/0246229 A1
(43) Pub. Date: Jul. 25, 2024

(54) CONSTRUCTION ROBOT HAVING A LIFTING DEVICE AND METHOD FOR PERFORMING WORK ON A BUILDING ELEMENT

(71) Applicant: Hilti Aktiengesellschaft, Schaan (LI)

(72) Inventors: Peer SCHMIDT, Lindau (DE); Dario BRALLA, Buchs (CH)

(21) Appl. No.: 18/413,247

(22) Filed: Jan. 16, 2024

(30) Foreign Application Priority Data
Jan. 23, 2023 (EP) 23152864.7

(51) Int. Cl. B25J 9/16; B25J 9/10; B25J 17/02

(52) U.S. Cl. CPC B25J 9/1612; B25J 9/1005; B25J 9/1664; B25J 9/1697; B25J 17/0291

(57) ABSTRACT

The invention relates to a construction robot (10) for performing work on a building element (12), comprising a mobile platform (14), a lifting device (16), which is arranged on the mobile platform (14), and a power tool (17), which is arranged on the lifting device (16) and in which a tool (18) can be received. It is characterized in that the construction robot (10) is configured to align the tool (18) obliquely to a surface normal (N) of a building element (12) on which work is to be performed, at an angle of incidence (alpha). Furthermore, the invention relates to a method (1000). The invention enables construction tasks to be carried out in a particularly flexible way.

The invention proceeds from a construction robot for performing work on a building element, comprising a mobile platform, a lifting device, which is arranged on the mobile platform, and a power tool, which is arranged on the lifting device and in which a tool can be received.

A construction robot of this kind can be configured to carry out construction tasks on a building element, e.g. a building ceiling. For example, it can be configured to drill holes into the building ceiling at predefined positions. By means of such a construction robot, construction workers can be relieved of otherwise physically very strenuous activities.

To allow broad use of such a construction robot, it should be possible to use the construction robot in a flexible way and to produce it as inexpensively as possible.

It is therefore the object of the present invention to offer a construction robot of the type stated at the outset which can be used in a particularly flexible way and can be produced inexpensively. Furthermore, the intention is to offer a method by means of which construction tasks on building elements can be carried out in a particularly flexible and inexpensive way.

The object is achieved by a construction robot for performing work on a building element, comprising a mobile platform, a lifting device, which is arranged on the mobile platform, and a power tool, which is arranged on the lifting device and in which a tool can be received, wherein the construction robot is configured to align the tool, in particular automatically, obliquely to a surface normal of a building element on which work is to be performed and/or to a vertical, at an angle of incidence.

The tool, e.g. a drill, a chisel, a setting tool or the like, usually has a longitudinal axis. Thus, the construction robot can be configured to align the tool in such a way that the longitudinal axis thereof is oblique to the surface normal, at an angle corresponding to the angle of incidence.

The construction robot can be motorized in order to adjust the angle of incidence automatically.

In particular, the construction robot can be configured to adjust the angle of incidence in accordance with a horizontal distance of the mobile platform, e.g. a central point of the mobile platform, from a working position at which a construction task is to be carried out on the building element.

Inter alia, the invention is based on the insight that, in the case of many types of construction tasks, it is not absolutely essential to set up the tool perpendicularly to the surface normal. For example, a borehole in a building ceiling, e.g. consisting of reinforced concrete, can be drilled obliquely to the surface normal, at a small, but not vanishingly small, angle of incidence. A concrete anchor can be set in the borehole, for example. The concrete anchor can then fully fulfil any load requirements and other safety requirements, despite the angle of incidence being different from 0°.

Particularly in the case of a large travel of the lifting device, setting the tool to a slightly oblique angle, e.g. by pivoting the lifting device relative to the surface normal, provides a surprisingly simple way of being able to reach a wide range along the surface of the building element with the tool without having to move the construction robot, in particular the mobile platform thereof, as a whole.

It is thereby possible to significantly simplify the control of the construction robot and the mechanism of the construction robot, e.g. of the lifting device. Production costs can thus be reduced. The low mechanical complexity allows a low total weight and/or a particularly compact construction. As a result, the construction robot is easy to transport, thus allowing it to be used in a particularly flexible way.

As a result, the construction robot, in particular the tool, can also reach working positions which it would otherwise not be possible to reach. As a result of this too, the construction robot can be used in a particularly flexible way.

Moving the construction robot as a whole, especially changing its position, is often very laborious, in particular very time consuming. After moving the mobile platform, for example, it may be necessary to completely re-determine a position and/or orientation of the construction robot, in particular of the tool.

Since the construction robot described here requires fewer movements for the sequential execution of a number of construction tasks at adjacent working positions of the building element, it is furthermore possible to increase its efficiency in the execution of construction tasks. This can lead to an additional reduction in overall costs for the construction tasks.

Conventional requirements on anchors can be met, and construction tasks such as drilling or chiselling can in each case be executed successfully if the angle of incidence remains sufficiently small. The angle of incidence can be, for example, at most 10°, in particular at most 5°, measured with respect to the surface normal.

The mechanical complexity of the lifting device can be particularly low, in particular with only a few degrees of freedom, if the mobile platform is configured to pivot at least one of the elements of a group of elements comprising the lifting device, the power tool and the tool relative to the surface normal. Alternatively or in addition, it is also conceivable for the lifting device to be articulated on the mobile platform via a joint, preferably a joint which can be releasably fixed and/or can be electrically controlled.

To ensure adequate security against tipping, the mobile platform can have at least three, preferably mutually independent, driving points. One driving point can be a wheel, a chain drive and/or a driving leg, for example. In order to be able to move the mobile platform, at least one, preferably at least two, of the driving points can be motor-drivable.

The mobile platform can comprise a wheeled chassis, for example. The wheeled chassis can have three or four wheels, for example.

The at least one element of the group of elements, e.g. the lifting device, is particularly easy to pivot if at least one of the driving points has a height adjuster. The driving point can thus be vertically adjustable. Adjusting the height adjuster enables an inclination of a support of the mobile platform to be adjusted. The lifting device can be arranged on the support. Thus, adjustment of the height adjuster enables the lifting device to be pivoted.

The height adjuster can have a lever arm. The lever arm can engage at one end on the support and at the other end on the driving point. By means of the height adjuster, it is then possible to adjust the height of the support at a point of engagement of the lever arm above an underlying surface on which the driving point is located.

The height of each individual driving point, i.e. of each individual point of engagement on the support, can be adjustable independently of the heights of the other driving points.

The construction robot can be configured to adjust the heights in such a way that a centre of gravity of the overall robot is situated above or on the support, in particular above or at a central point of the support. The construction robot can thus be balanced at all times. It is thus possible to ensure that the construction robot does not fall over, even on uneven underlying surfaces.

It is also conceivable for at least one of the driving points, in particular the height adjuster of the driving point, to be of self-locking design. A self-locking driving point can be designed in such a way that it can only be adjusted by active, e.g. electrically controlled, actuation. In the event of a fault, e.g. a power failure, the construction robot can thus remain in its respective last position before the fault. Any consequential damage due to the fault can thus be avoided. If, for example, the construction robot is designed to drill holes in building ceilings and, for this purpose, has a lifting device with a relatively large travel, e.g. a travel of at least 4 m, and if the construction robot is battery-powered, then in the case of an empty battery, that is to say in the event of a power failure, it is possible to ensure that the construction robot remains in its last, generally balanced, position. This ensures that the construction robot does not fall over on account of the power failure. Severe consequential damage, e.g. personal injury due to the construction robot falling over, can thus be avoided. As a result of this too, it is possible to extend the possible uses of the construction robot, and the construction robot can be used in a more flexible way.

The pivoting of the lifting device makes it possible to manage without some degrees of freedom of the lifting device. A lifting device with a small number of degrees of freedom may entail low production costs. Owing to lower mechanical complexity, a lifting device of this kind may also be less susceptible to faults. For example, the lifting device may have at most two degrees of freedom, preferably precisely one degree of freedom. The lifting device may have only a one-dimensional linear drive, for example.

For particularly flexible use of the construction, it can be of portable design. In particular, the construction can have a total weight of less than 50 kg, in particular less than 25 kg. Alternatively or in addition, it is also conceivable for this purpose for the construction robot, or at least the lifting device, to be capable of being reversibly disassembled into individual parts, preferably without tools. Each of the individual parts can weigh less than 50 kg, e.g. less than 25 kg, and therefore each individual part and hence also the construction robot can be carried without problems.

The construction robot can be operable in at least two operating modes.

In a first operating mode, the construction robot can be configured to align the tool automatically with a working position, in particular a predetermined working position. The working position can correspond, for example, to a position at which a hole is to be drilled, at which chiselling is to be performed, at which a construction element, such as a concrete anchor, in particular a concrete plug or a concrete screw, is to be set, or some other construction task of this kind which is to be carried out at the working position. For automatic alignment with the working position, the construction robot can be configured to determine its own position and/or orientation. It may be configured to determine a position and/or orientation of the working position. In particular, it may be configured to determine a relative position and/or relative orientation of the construction robot with respect to the working position. It may be configured to determine the angle of incidence on the basis of the positions, orientations, relative positions and/or relative orientations. It may then be configured, in accordance with the angle of incidence determined, to move the lifting device and/or to move the mobile platform, in particular in order to reduce a large angle of incidence.

In a second operating mode, the construction robot can be configured in such a way that the angle of incidence can be set by manual guidance. It is conceivable for the construction robot to be configured in such a way that a user of the construction robot can move at least one of the elements of the group of elements, e.g. the lifting device, in particular by contact with the lifting device and/or by exerting a pressure force on the lifting device. The construction robot can be configured to compensate for weight forces, especially during manual guidance such that, although the construction robot changes position due to contact or to the pressure force, it does not fall over as a whole.

In particular, the angle of incidence can be capable of being set by manual guidance. Thus, the user can align the tool with the working position with just a small expenditure of force. In particular, it is conceivable for the user to initially move the construction robot to a starting position. By pivoting, e.g. pivoting the lifting device, the user can then successively align the tool with different working positions that are sufficiently close together and can carry out the respectively desired construction tasks at the respective working positions.

The construction robot can be configured in such a way that a construction task, e.g. a drilling process, is started and/or is carried out in a fully automatic way by the actuation of an actuating element, e.g. a button. For example, the construction robot can be configured, in response to actuation of the actuating element, to drill into the building element as far as a predefined depth and then to pull the tool out of the drilled borehole again and, preferably, to retract the lifting device again as far as a predefined final height position.

If the building element on which work is to be performed is a building ceiling, the user can thus perform the respectively desired construction tasks from a distance and is thus spared physically highly demanding overhead work.

The construction robot may be suitable for use with different types of power tools and tools.

Examples of tools can be drilling tools, especially for hammer drilling in masonry, steel drilling tools or wood drilling tools, chiselling tools or setting tools. Setting tools can be, for example, tools for setting, in particular for setting fastening elements such as screws, nails, anchors or dowels. It is also conceivable that the tool is a marking tool, e.g. a paint spray nozzle. It is also conceivable that the tool is a monitoring tool and/or a measuring tool, e.g. it can comprise a distance meter and/or a camera.

As with the tools, the power tools can be power drills, in particular hammer drills, power chisels, setting devices, e.g. direct setting devices for setting nails, power screwdrivers, such as drivers with or without impact, or the like.

The building element can be, for example, a building ceiling, a building wall and/or a building floor.

The larger the travel of the lifting device and/or the longer the lifting device overall, the smaller the maximum required deflection with which the lifting device is pivoted relative to the surface normal, and hence the angle of incidence, can be in order nevertheless to cover a sufficiently large range of working positions without having to move the construction robot. With a large travel and/or long lifting devices, it is also possible, for example, to reach very high building ceilings, and therefore the possible uses of the construction robot can be further extended by lifting devices of this kind.

It is therefore advantageous if the travel of the lifting device and/or a maximum total length of the lifting device are/is at least 3 m, preferably at least 4 m, particularly preferably at least 5 m. For this purpose, the lifting device can also be of multi-part design. To save weight, one of several parts of the lifting device can be capable of manual length adjustment. Another part of the lifting device can be electrically extendable.

The construction robot can have an acceleration and/or inclination sensor, e.g. an inertial measurement unit, referred to below as “IMU”. The acceleration sensor and/or the inclination sensor can be arranged on the mobile platform. Alternatively or in addition, they can also be arranged on the lifting device and/or on the power tool.

The construction robot can be configured to determine an angle of inclination of the lifting device and/or of the mobile platform by means of the acceleration sensor and/or of the inclination sensor, and it can further be configured to compensate for irregularities, slopes etc. of an underlying surface on which the construction robot is located by means of the inclination angle, e.g. by means of the height adjuster, and/or to determine by means of the angle of inclination whether and/or how the tool can reach and/or already has reached a desired angle incidence.

The construction robot may be formed for performing construction tasks on a building construction site and/or a civil engineering construction site.

The lifting device may also comprise a multi-axis arm.

By virtue of the possibility of setting the angle of incidence and thus of being able to reach a range of working positions from one position of the mobile platform, it is not necessary for the mobile platform to manoeuvre in a particularly tight space. The mobile platform can therefore also be designed without a steering axle and/or without steerable driving points. It is thereby possible to further reduce the mechanical complexity of the construction robot.

To control one or more, preferably all, of the above-described functionalities of the construction robot, the construction robot can have a control computer.

The control computer can have a processor, a memory unit and a program code that can be executed by the processor. The processor may have one or more sub-processors. The program code can be configured, when executed on the processor, to implement one or more of the functionalities, in particular all of the functionalities, by controlling the corresponding elements of the construction robot.

In particular, the program code can be configured to set a predefined and/or determined angle of incidence. Alternatively or in addition, the program code can be configured to pivot at least one of the elements of the group of elements.

The construction robot may have a contact arm. The contact arm can be configured to make contact with the building element before, during and/or after the execution of a construction task. For example, the contact arm can be arranged parallel or at least substantially parallel to the power tool and/or to the tool. The contact arm can be telescopic and/or movable independently of the lifting device. It may then be possible that the construction robot comes into contact with the building element, in particular touches the latter with its contact arm and/or is fixed thereon by means of the contact arm. It can be fixed on the building element, for example, by means of non-positive engagement, e.g. by means of a vacuum, by material bonding and/or by form fitting, e.g. by the penetration of a rod-shaped section of the contact arm into a borehole prepared beforehand. By means of the contact arm, it is thus possible to improve stability during the execution of the construction task. This can be useful, for example, in the case of construction tasks with large tools, e.g. core drills.

The construction robot can have a camera for recording images. The camera can be designed, in particular aligned, in such a way that it records one or more images of a region containing the tool and/or the working position. Images can then be viewed by a user of the construction robot on an operator device, for example, e.g. a smart phone or a remote control for controlling the construction robot. In this way, a construction task to be performed can be monitored without the user having to look toward the building element, e.g. toward the building ceiling. This too can relieve the user of more physical stress. A construction robot for carrying out construction tasks on building elements, having a power tool into which a tool can be received, and a camera which is configured to record images of a region which contains the tool and/or a working position on the building element may therefore already be particularly advantageous per se and, in particular, may reduce physical stresses on a construction worker. The construction robot can have an observation device, e.g. in the form of a smart phone and/or a remote control for remotely controlling the construction robot, which has a display. The observation device can be configured to display images recorded by the camera. Such a construction robot may also have one or more of the features of a construction robot which are described above and/or below.

In particular, the construction robot may be configured for construction tasks on building ceilings and/or building walls. For this purpose, the power tool can be mountable in a vertical and/or a horizontal orientation on the lifting device.

Also within the scope of the invention is a method for performing work on a building element, e.g. for drilling or chiselling the building element or for setting a fastening element in the building element, with a construction robot which comprises a power tool, e.g. a power drill or a power chisel, wherein a tool, e.g. a drilling tool or a chiselling tool, by means of which work is performed on the building element, is received in the power tool, wherein the tool is aligned obliquely to a surface normal of the building element, at an angle of incidence, by the construction robot.

By virtue of the oblique alignment of the tool, a relatively wide range of working positions can be reached with the tool without having to move the construction robot as a whole. Work at adjacent working positions can be carried out quickly and therefore efficiently and economically. The construction robot can be of mechanically low complexity, ensuring that its production costs can be low. It can have a low weight, thereby enabling its possible uses to be additionally extended.

The angle of incidence can be small. For example, it may be at most 10°, in particular at most 5°, measured with respect to the surface normal. In the case of a large travel and/or a long overall length of the lifting device, even smaller angles of incidence, e.g. of no more than 1°, may be sufficient to enable a sufficiently large range of working positions to be covered without moving the construction robot.

The tool can be aligned easily if a mobile platform of the construction robot pivots at least one of the elements of a group comprising the lifting device, the power tool, and the tool relative to the surface normal.

The method can be carried out with a construction robot which has at least one feature of a construction robot of the type described above.

In particular, it is conceivable that the construction robot, in particular a program code of a control computer of the construction robot, is configured to carry out the method by controlling further elements of the construction robot.

Further features and advantages of the invention are apparent from the following detailed description of exemplary embodiments of the invention, with reference to the figures of the drawings which show details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawing and elucidated in detail in the description that follows.

### IN THE FIGURES

FIG. 1 shows a construction robot and a building element in an oblique perspective view,

FIG. 2, 3, and FIG. 4 show the construction robot according to FIG. 1 in a view from the side (FIG. 2), in a view from above (FIG. 3) and in a view from below (FIG. 4),

FIG. 5 shows a schematic illustration of an angle of incidence of the construction robot with respect to the building element, and

FIG. 6 shows a method for performing work on a building element.

In the description of the figures that follows, comprehension is facilitated by use of the same reference signs in each case for identical or functionally corresponding elements throughout the various figures.

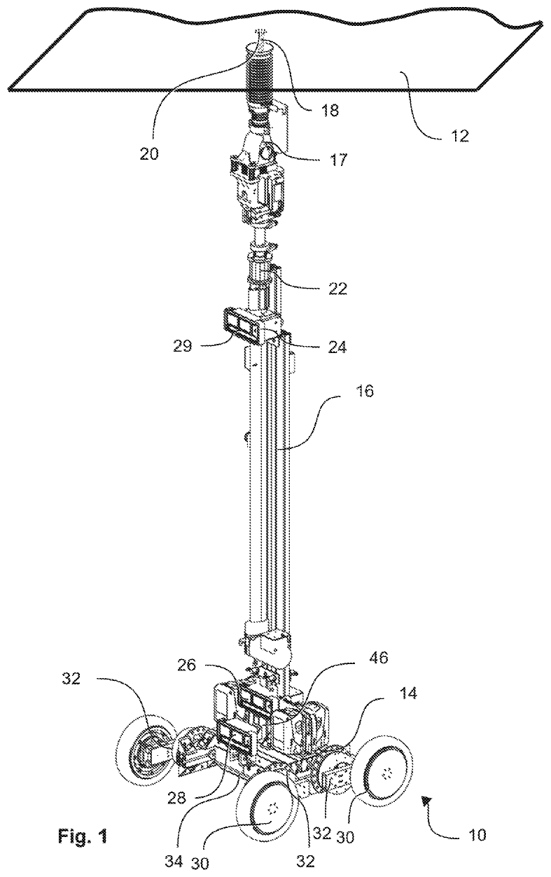

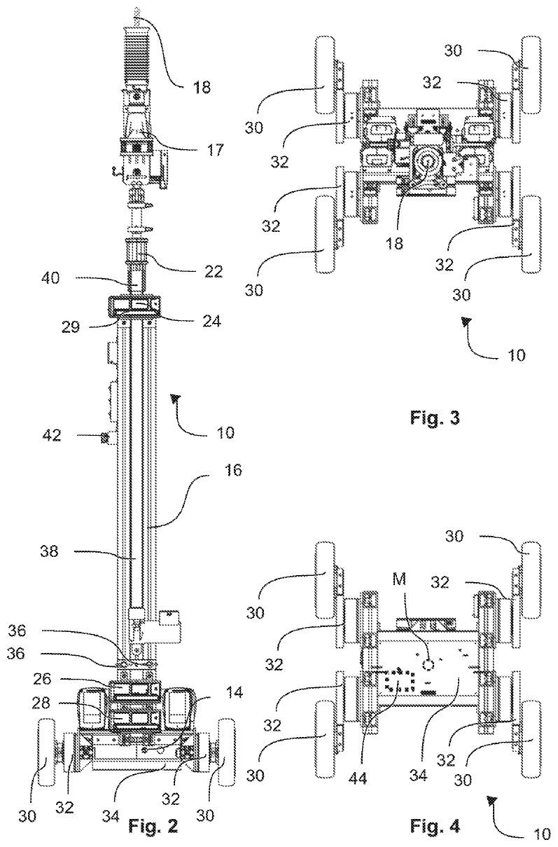

FIG. 1 shows a construction robot 10 for performing work on a building element 12. FIG. 2 shows a side view of the construction robot 10. FIG. 3 and FIG. 4 show a view of the construction robot 10 from above and from below, respectively.

The construction robot 10 comprises a mobile platform 14, a lifting device 16 and a power tool 17 arranged on the lifting device 16. A tool 18 is received in the power tool 17. The tool 18 makes contact with a working position 20 on the building element 12. Situated along the lifting device 16 are a prism 22 and a first line sensor 24, a second line sensor 26, and a third line sensor 28. The construction robot 10 furthermore comprises a control computer 46.

The power tool 17 is configured as a hammer drill. The tool 18 is a concrete drill.

The building element 12 is a building ceiling consisting of reinforced concrete.

The construction robot 10 is configured to drill a hole into the building element 12 designed as a building ceiling at the working position 20.

The line sensors 24, 26, 28 are configured to detect the position of incident light beams or light spots. For this purpose they each have a light-sensitive sensor line 29. To simplify the illustration, only one of the sensor lines 29 is provided with a reference sign in FIG. 1. The light-sensitive sensor lines 29 can have a width of, for example, 10 cm. Matrices of light-sensitive individual sensors extend across the width of the sensor lines 29.

The first line sensor 24 and the second line sensor 26 are arranged in a vertically offset manner one above the other. The third line sensor 28 is arranged obliquely forwards below the second line sensor 26. By means of the three light sensors 24, 26, 28, the profile of a line light beam that indicates the working position 20, e.g. a correspondingly aligned laser beam, can be detected. From the detected profile of the line light beam it is possible to infer the position of the working position 20. If it is known, for example, that the line light beam is aligned in a precisely vertical manner, it is possible, as an alternative or in addition, to use the three line sensors 24, 26, 28 to determine an angle of inclination of the lifting device 16.

As an alternative or in addition, the prism 22, in combination with a total station for example, can be used to determine a position and/or orientation of the construction robot 10 and, in particular, of the tool 18.

The mobile platform 14 has four driving points 30, of which only three driving points 30 can be seen in FIG. 1 for presentation reasons. The driving points 30 have wheels. The wheels are directional wheels. It is not necessary, but it is conceivable, that the wheels are omnidirectional wheels.

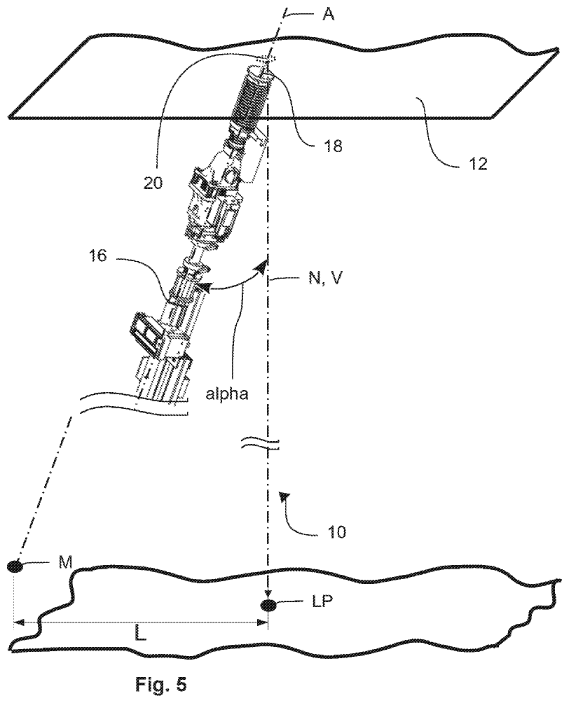

Each of the driving points 30 has a height adjuster 32. The height adjusters 32 engage on a support 34. The lifting device 16 is arranged on the support 34. By means of the height adjusters 32 it is thus possible to pivot the support 34. By pivoting the support 34, it is thus also possible to pivot the lifting device 16 and the power tool 17 connected to it, and hence the tool 18. As will be explained in greater detail below in connection with FIG. 5, the construction robot 10 can thus pivot the mobile platform 14, the lifting device 16 and hence the power tool 17 with its tool 18 relative to a surface normal of the building element 12 by means of the height adjusters 32 of the mobile platform 14.

The height adjusters 32 are of self-locking design. For this purpose, they may have a worm gear mechanism. Thus, the height adjusters 32 and hence an angle of inclination of the mobile platform 14 are adjusted only when the worm gear mechanisms are moved, e.g. by means of a servomotor.

The lifting device 16 has a single degree of freedom. In particular, it is of variable length. As can be seen, in particular, from FIG. 2, fixing levers 36 can be used to release a lower part 38 of the lifting device 16, to move it manually along the rest of the lifting device 16, and then to fix it on the rest of the lifting device 16 again. In this way, the construction robot 10 can first of all be set manually roughly to a first length or height, from which the construction robot 10 can automatically extend an upper part 40 of the lifting device 16 as required, in particular in an electrically driven manner, until the tool 18 reaches the working position 20 or, where applicable, penetrates into the building element 12 at this position.

Overall, the construction robot 10 is dimensioned in such a way that its total weight is less than 50 kg. If, as illustrated in FIG. 1 and FIG. 2 for example, the construction robot 10 is retracted as far as a minimum length, it has a height of less than 1.5 m, for example. The mobile platform 14 occupies an area of less than 60×60 cm. As a result of this too, the construction robot 10 can be carried without problems by a construction worker and can be transferred within conventional buildings, e.g. from one room to another.

The construction robot 10 furthermore has an operating mode selector switch 42 (see especially FIG. 2). The operating mode selector switch 42 makes it possible to operate the construction robot 10 in a first operating mode, in which the robot automatically approaches the working position 20 with its tool 18. In a second operating mode, the construction robot 10 can be controlled by manual guidance. In the second operating mode, it is possible in particular for the lifting device 16 to be pivoted manually in a desired direction by appropriately directed pressure.

FIG. 4 schematically depicts an IMU 44. The IMU 44 is located on the support 34 and is therefore not visible in the view of the construction robot 10 from below in FIG. 4.

FIG. 4 furthermore shows a central point M of the support 34.

The construction robot 10 is configured to measure accelerations and angles of inclination of the support 34 with respect to the horizontal by means of the IMU 44. In this way, it is possible to detect irregularities in the underlying surface, for example, by means of the IMU 44. The construction robot 10 is furthermore configured to compensate such angles of inclination and/or irregularities, in particular during a movement of the mobile platform 14, by means of the height adjusters 32, and therefore the construction robot 10 is continuously protected from falling over.

FIG. 5 will be used to explain in greater detail how the tool 18 is aligned obliquely to a surface normal N of the building element 12 upon which work is to be performed, with its longitudinal axis A at an angle of incidence alpha.

For this purpose, by way of simplification, FIG. 5 shows part of the lifting device 16. In particular, FIG. 5 shows that the tool 18 makes contact obliquely with the building element 12 at the working position 20. This gives the angle of incidence alpha, which, in particular, differs from zero, between the longitudinal axis A of the tool 18 and the surface normal N through the working position 20. Since, in this case, the building element 12 extends horizontally, corresponding to a building ceiling, the surface normal N also extends parallel to a vertical V in the exemplary embodiment illustrated.

Here, for presentation reasons, the angle of incidence alpha is considerably exaggerated in FIG. 5. In an actual use case, the angle of incidence alpha can be less than 10°, in particular less than 5°, particularly preferably less than 1°, and, for example, more than 0.1°.

It can be seen that the oblique positioning of the tool 18 in accordance with the angle of incidence alpha results in the central point M of the support 34 (see FIG. 2) being at a horizontal distance L from a plumb point LP obtained from the perpendicular dropped from the working position 20 to the underlying surface. As a result, the central point M is likewise at the horizontal distance L from the working position 20.

Thus, the construction robot 10 is configured to perform a construction task, in this case drilling a hole, at the working position 20, even if the mobile platform 14, in particular the central point M, is not vertically below the working position 20. This eliminates the task of manoeuvring the mobile platform 14 in an appropriate manner to bring the central point M vertically below the working position 20. It is evident that it is thereby possible to reach even working positions 20 which it would otherwise be impossible to reach for lack of free space for the mobile platform 14. As a result, edge regions of the building element 12 in particular can be reached for the first time or at least more easily.

In the second operating mode, i.e. the manual operating mode, the angle of incidence can be set by manual guidance of the lifting device 16. In particular, the lifting device 16 can be pivoted by pressure on the latter. Here, the construction robot 10 is configured to limit a maximum permitted deflection and thus the maximum achievable angle of incidence alpha to such an extent that, in this operating mode too, the construction robot 10 cannot fall over at any time.

In both operating modes, the construction robot 10 is configured to set or support the respectively achieved inclination of the lifting device 16 and hence of the angle of inclination alpha by follow-up adjustment of the height adjusters 32. In the second operating mode, this has the effect, for example, that a manually set inclination of the lifting device 16 is maintained after the lifting device 16 is released. Thus, the user can approach the working position 20 with the tool 18 by extending the lifting device 16, e.g. under control by way of a remote control (not shown).

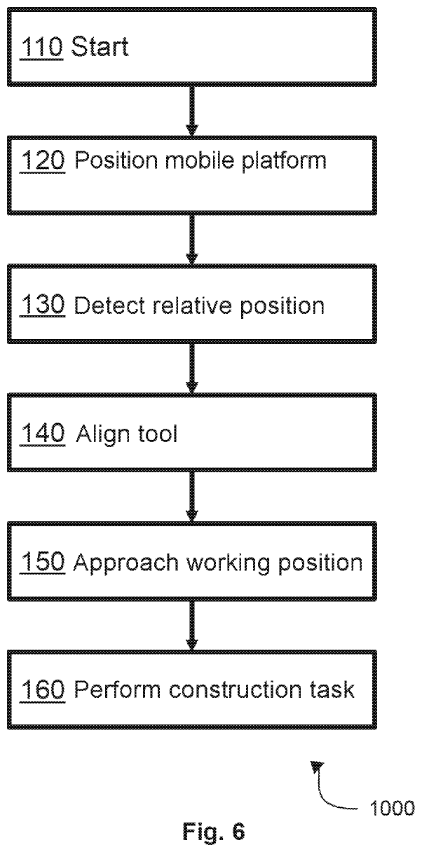

Finally, FIG. 6 shows a method 1000 for performing work on a building element.

To explain the method 1000, reference is made to the above-described FIGS. 1 to 5 and the reference signs introduced there.

The method 1000 is likewise illustrated using the example of drilling a hole at the working position 20 of the building element 12 by means of a construction robot, e.g. the construction robot 10.

During a start 110, the construction robot 10 is prepared for carrying out a desired construction task, in this case drilling a hole at the working position 20. It is possible, for example, especially in the case of high ceilings, to extend the lower part 38 of the lifting device 16 initially by a certain amount, e.g. one metre, manually, thus enabling the upper part 40 of the lifting device 16 then to reach the building element 12, i.e. the building ceiling, with the tool 18 and to penetrate it in order to drill the hole.

The construction robot 10 can then be positioned roughly in a phase 120.

In particular, the mobile platform 14 can be positioned on the underlying surface in the vicinity of the plumb point LP under the working position 20. The horizontal distance L between the central point M of the mobile platform 14 and the plumb point LP should at a maximum be such that the tool 18 can be aligned with the working position 20 by pivoting the lifting device 16 and can be extended to this position without the construction robot 10 becoming unbalanced and/or falling over. Likewise, the angle of incidence alpha required to reach the working position 20 should be within the permissible range for the purpose of the construction task to be carried out. For the drilling of a hole, which is chosen as an example here, into which hole a screw anchor, for example, is subsequently to be screwed, all the building regulations etc. relating to the screw anchor should thus be complied with, even at the maximum angle of incidence alpha.

In the illustrative case of the screw anchor, this can mean, for example, that the angle of incidence alpha must be no more than 5°. In the case of a ceiling height of, for example, 5 m, the distance L should thus be up to about 0.4 m.

In a subsequent phase 140, a relative position is then determined between the tool 18, in particular a tip of the tool 18, and the working position 20. This can be accomplished, for example, by determining a position and an orientation of the tool 18 by means of a total station, the prism 22 and the IMU 44. The working position 20 can be colour-marked, thus enabling the position of the working position 20 also to be determined by means of the total station, for example. From a comparison of the two positions determined, the relative position can then be derived.

In a further phase 140, the tool 18 is aligned with the working position 20. For this purpose, the relative position determined is first of all used to calculate the angle of inclination by which the lifting device 16 must be pivoted to align the tool 18. The support 34 and thus the lifting device 16 are then correspondingly pivoted by means of the mobile platform 14, in particular by means of the height adjusters 32, until the lifting device 16 reaches the desired angle of inclination.

In a subsequent phase 150, the lifting device 16 is extended until the tool 18 reaches the working position 20. In other words, the tool 18 approaches the working position 20.

In a further phase 160, the construction task to be carried out is carried out at the working position 20. According to the example taken as a basis here, the power tool 17, in particular, is activated, with the result that the tool 18 begins to drill a hole at the working position 20. For drilling, the lifting device 16 is adjusted according to the progress of the drilling.

As soon as the tool 18 has drilled the hole to the desired depth, the lifting device 16 is at least partially retracted again in order to withdraw the tool 18 from the hole.

The power tool 17 is then deactivated.

If there are additional working positions at which work is to be performed, corresponding to the working position 20, in the range that can be reached by the tool 18 by tilting the lifting device, the method 1000 can be repeated at a shortened interval, beginning in phase 130, i.e. detection of the relative position.

Once the work has been performed at all the working positions 20 within the range, the method 1000 can be ended.

### LIST OF REFERENCE SIGNS

10 Construction robot
12 Building element
14 Mobile platform
16 Lifting device
17 Power tool
18 Tool
20 Working position
22 Prism
24 Line sensor
26 Line sensor
28 Line sensor
29 Sensor line
30 Driving point
32 Height adjuster
34 Support
36 Fixing lever
38 Lower part
40 Upper part
42 Operating mode selector switch
44 IMU
46 Control computer
110 Start
120 Phase
140 Phase
150 Phase
160 Phase
1000 Method
A Longitudinal axis
L Distance
LP Plumb point
M Central point
N Surface normal
V Vertical
alpha Angle of incidence

1. A construction robot for performing work on a building element, comprising a mobile platform, a lifting device (16), which is arranged on the mobile platform, and a power tool, which is arranged on the lifting device and in which a tool can be received, wherein
the construction robot is configured to align the tool obliquely to a surface normal (N) of a building element upon which work is to be performed, at an angle of incidence (alpha).

2. The construction robot according to claim 1, wherein the angle of incidence (alpha) is at most 10° measured with respect to the surface normal (N).

3. The construction robot according to claim 1, wherein the mobile platform is configured to pivot at least one of the elements of a group of elements comprising the lifting device, the power tool, and the tool relative to the surface normal (N) and/or to a vertical (V).

4. The construction robot according to claim 1, wherein the mobile platform has at least three independent driving points.

5. The construction robot according to claim 4, wherein at least one of the at least three independent driving points has a height adjuster.

6. The construction robot according to claim 4, wherein at least one of the at least three independent driving points is of self-locking design.

7. The construction robot according to claim 1, wherein the lifting device has at most two degrees of freedom.

8. The construction robot according to claim 1, wherein the construction robot has a total weight of less than 50 kg, and/or in that the construction robot can be reversibly disassembled into individual parts, wherein each of the individual parts weighs less than 50 kg.

9. The construction robot according to claim 1, wherein the construction robot is configured in such a way that the angle of incidence (alpha) can be set by manual guidance.

10. The construction robot according to claim 1, wherein the construction robot has a camera for recording images, wherein the camera is designed, in such a way that it records one or more images of a region containing the tool and/or the working position.

11. A method for performing work on a building element with a construction robot which comprises a power tool, wherein a tool, by which work is performed on the building element, is received in the power tool, the method comprising
aligning the tool obliquely to a surface normal (N) of the building element and/or to a vertical (V), at an angle of incidence (alpha), by the construction robot.

12. The method according to claim 11, comprising measuring the angle of incidence (alpha) of at most 10° with respect to the surface normal (N).

13. The method according to claim 11, wherein a mobile platform of the construction robot pivots at least one of the elements of a group of elements comprising the lifting device, the power tool, and the tool relative to the surface normal (N).

14. The construction robot of claim 2, wherein the angle of incidence (alpha) is at most 5°, measured with respect to the surface normal (N).

15. The construction robot of claim 6, wherein the height adjuster of the at least one of the at least three independent driving points is of self-locking design

16. The construction robot of claim 7, wherein the lifting device has precisely one degree of freedom.

17. The construction robot of claim 8, wherein the construction robot has a total weight of less than 25 kg, and/or in that the construction robot can be reversibly disassembled into individual parts, wherein each of the individual parts weighs less than 25 kg.

18. The construction robot of claim 8, wherein the construction robot can be reversibly disassembled into individual parts without tools.

19. The construction robot of claim 10, wherein the camera is aligned in such a way that it records one or more images of a region containing the tool and/or the working position.

20. The method of claim 12, comprising measuring the angle of incidence (alpha) of at most 5° with respect to the surface normal (N).
